(19) United States
(12) Patent Application Publication
(10) Pub. No.: US 2013/0192635 A1
(43) Pub. Date: Aug. 1, 2013

(54) Phone Display Wiping Case

(71) Applicant: Shanyao Lee, Irvine, CA (US)

(72) Inventor: Shanyao Lee, Irvine, CA (US)

(21) Appl. No.: 13/363,319

(22) Filed: Jan. 31, 2012

(51) Int. Cl. H04M 1/17; H04M 1/04; B08B 1/00

(52) U.S. Cl. 134/6; 15/104.93; 206/45.24

(57) ABSTRACT

A method and apparatus for wiping dust, oils, and dirt off of the display of a phone when inserting said phone into a phone case. Such method and apparatus providing for a more convenient and more complete cleaning of the display of the phone during regular use of said phone case.

### FIELD OF THE INVENTION

The application relates to methods and mechanisms for wiping dust, oils, and other unwanted particles off of the display screen of a phone, particularly to such methods and mechanisms whereby said display screen of phone may be wiped via a phone case.

### BACKGROUND OF THE INVENTION

### Prior Art

During the course of a day, a standard phone display screen picks up dust, oils and dirt that looks undesirable and may be harmful to the phone's proper usage.

Presently, those who wish to remove the dust, oils, and dirt from the displays of their phones must manually wipe away the unwanted material using small, easy to lose wipes. These wipes often do not properly clean the display, and leave much of the unwanted materials remaining on the display. Presently, standard phone cases are often used to protect phones from damage due to falls or collisions and protect the phones from general wear and tear due to environmental issues, but these cases do not keep the phone clean from dust, oils and dirt that can still accumulate on the display.

There exists a need for a phone case that can evenly wipe the display of a phone free from unwanted particles simply through regular use of the case.

### Objects and Advantages

Accordingly, several objects and advantages of this invention are:
(a) to provide a quick and effective way to wipe the display of the phone from unwanted particles of dust, oils, and dirt;
(b) to protect the phone from harmful damage due to falls or other collisions;
(c) to, in certain embodiments, allow the phone case to lean on an integrated stand, such that the user may view the phone in a visually appealing and physically stable manner;
(d) to prevent damage to the display of a phone due to an overabundance of dust, oils, or dirt corroding the display surface;
(e) to, in certain embodiments, disinfect, sterilize or otherwise clean the phone display with a chemical based, oil based, or water based cleaning agent;
(f) to, in certain embodiments, make the odor of the phone more favorable to the user.

Further objects and advantages of this invention will become apparent from a consideration of the drawings and ensuing description.

### SUMMARY OF THE INVENTION

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

In accordance with the present invention a method and apparatus for wiping the display of a phone clean of particles of dust, oils, and dirt that may have accumulated on the surface of said display during regular usage whereby said method and apparatus involves inserting the phone into a phone case.

### BRIEF DESCRIPTION OF THE DRAWINGS

For a better understanding of the aforementioned embodiments of the invention as well as additional embodiments thereof, reference should be made to the Detailed Description below, in conjunction with the following drawings in which like reference numerals refer to corresponding parts throughout the figures.

FIG. 1 is a perspective view of the front face of the phone, according to certain embodiments.

FIG. 2 is a perspective view of the front face and inner face of the phone wiping case, according to certain embodiments.

FIG. 3 is a perspective view of the phone as it is inserted into the phone wiping case, according to certain embodiments.

FIG. 4 is a perspective view of the phone inside the phone wiping case, according to certain embodiments.

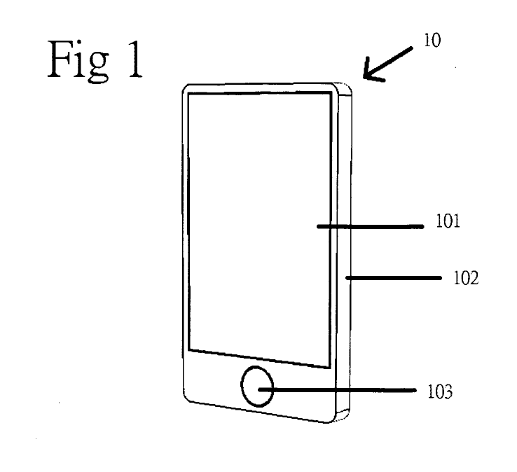

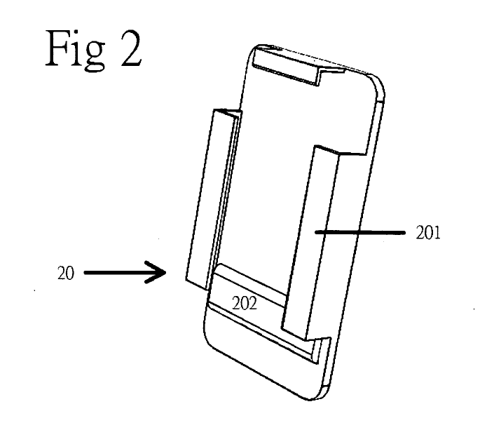

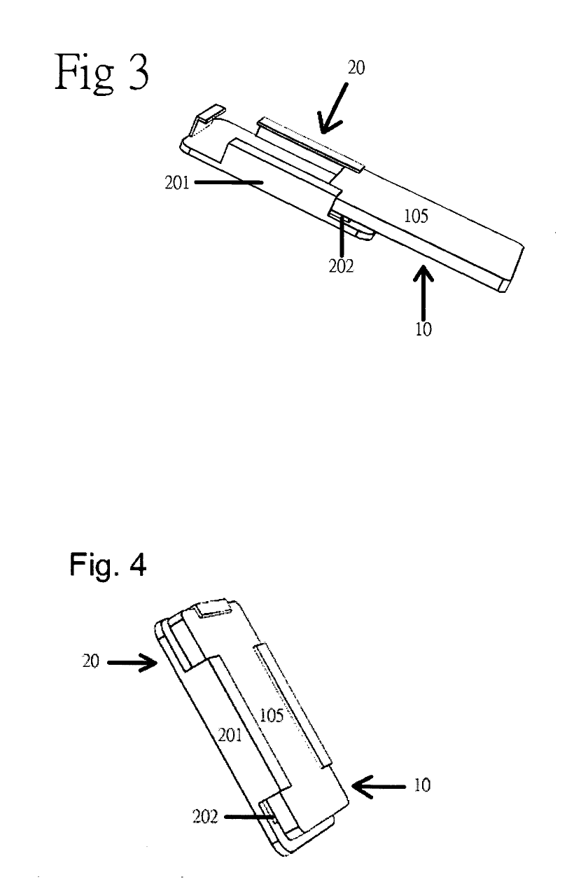

### DETAILED DESCRIPTION—FIGS. 3,4

With reference now to the drawings, the preferred embodiment of the phone display wiping case according to the present invention is herein described, as can be seen in FIG. 4, the phone case 20 snugly clasps phone 10 with phone clasps or grasping mechanisms 201. Phone display or screen 101 is part of phone 10.

As can be seen in FIG. 3, during regular use of phone case 20 phone display or screen 101 of phone 10 touches phone wiping bump 202. Phone 10 fits snugly in phone case 20 and is held by phone clasps or grasping mechanisms 201.

The invention may be embodied in other forms without departing from the spirit or essential characteristics thereof. The present embodiments are therefore to be considered as illustrative and not restrictive, the scope of the invention being indicated by the appended claims rather than by the foregoing description, and all changes that come within the meaning and range of equivalency of the claims are therefore intended to be embraced therein.

Operation—FIGS. 3,4

As can be seen in FIG. 3, in some embodiments, the phone 10 is inserted snugly into phone case 20 and phone wiping bump 202 comes into contact with phone display/screen 101 such that as phone 10 is inserted into phone case 20 as in regular use, phone display/screen 101 is wiped or cleaned by phone wiping bump 202 as the two rub against one another. In certain embodiments, when phone 10 rubs against phone wiping bump 202, phone wiping bump 202 releases a pleasant odor or disinfects, sterilizes or otherwise cleans the phone display with a chemical based, oil based, or water based cleaning agent.

As can be seen in FIG. 4, in some embodiments, when the phone 10 is being held at rest within phone case 20, phone 10 does not move about within phone case 20, but rather is held in snugly.

### CONCLUSION, RAMIFICATIONS, AND SCOPE

Thus, the reader will see that the method and apparatus for the cleaning of a phone display by inserting it into a case provides for more efficient and effective wiping of the phone display.

While the above description contains many specifications, these should not be construed as limitations of the scope of the invention, but rather as an exemplification of a preferred embodiment of the invention. Many other variations and embodiments are possible.

Accordingly, the scope of the invention should be determined not by the embodiment illustrated, but by the appended claims and their legal equivalents.

We claim:

1. A method for cleaning the display of a phone comprising:
A casing or covering for a phone;
Said casing or covering further comprising a bump on which the phone display may be wiped;

2. The bump in claim 1 wherein said bump is used to clean or wipe off dust, oils, dirt, and other unwanted particles from the display of the phone.

3. The bump in claim 1 wherein said bump is integrated with or within said phone casing or covering.

4. The bump in claim 1 wherein said bump carries a disinfectant or other cleaning agent.

5. The bump in claim 1 wherein said bump carries a scented odor.

6. The casing or covering for the phone in claim 1 wherein said casing or covering further comprises a means to lean the phone case on a stand;

7. The stand from claim 6 wherein said stand is integrated with the phone case.

8. The stand from claim 6 wherein said stand is used to enhance viewing of the phone display.

9. The casing or covering in claim 1 wherein said casing or covering also provides added protection to the phone.
